(19) United States
(12) Patent Application Publication
(10) Pub. No.: US 2002/0129982 A1
(43) Pub. Date: Sep. 19, 2002

(54) Snowmobile drive train

(76) Inventors: Kent H. Harle, Carlsbad, CA (US); William M. Savage, Bonsal, CA (US)

Correspondence Address: Mitchel P. Brook, LUCE, FORWARD, HAMILTON & SCRIPPS, 11988 EL Camino Real, Suite 200, San Diego, CA, 92130, US

(21) Appl. No.: 09/805,416

(22) Filed: Mar. 13, 2001

(51) Int. Cl. B62M 27/02

(52) U.S. Cl. 180/182

(57) ABSTRACT

A snowmobile drive train employing a drive belt and an endless track is provided. The snowmobile comprises an engine including an output shaft, with a support member located adjacent to the engine. A drive pulley and a driven pulley are mounted on the support member so that the drive belt can be removed from the snowmobile by passing the drive belt over the pulleys. An isolation member couples the engine output shaft to the driven pulley, and the support member maintains the drive and driven pulleys in a constant positional relationship relative to each other. The support member also includes reduction gears for driving the endless track.

### FIELD OF THE INVENTION

The present invention generally relates to snowmobiles. More particularly, the invention concerns a snowmobile with an improved drive train.

### BACKGROUND OF THE INVENTION

A drive train is the transmission system that connects a vehicle's engine output shaft to the vehicle drive axle or axles. For example, automobile drive trains may include a transmission, drive shaft, and drive axles. Snowmobile drive trains generally include a variable ratio belt drive system having a driving pulley that is directly coupled to the engine output shaft. The driving pulley usually includes a centrifugal clutch through which the drive ratio of the belt drive varies as a function of engine speed and torque. The drive belt connects the drive pulley to a driven pulley that is coupled to a jack shaft which in turn drives a chain and sprocket reduction drive. The reduction drive is coupled to an axle that drives sprocket wheels, which turn an endless track. This arrangement suffers a number of drawbacks, one of which is that the engine heat, vibrations and movements are directly translated to the driving pulley.

Snowmobile engines are generally attached to the frame by rubber isolation mounts, to minimize vibration transmitted to the operator. However, the rubber mounts allow the engine to vibrate and move, which also allows the drive pulley to move. The efficiency of the belt drive system is decreased by any variation in the relative position and/or alignment of the two pulleys. The forces present in the drive belt during operation create a force that tends to pull both pulleys together. Therefore, with the engine mounted on flexible rubber supports, the position and alignment of the drive pulley relative to the driven pulley varies constantly during snowmobile operations, decreasing drive train efficiency.

Moreover, the misalignment between the two pulleys causes heat to build up in the drive belt, decreasing the operating life of the drive belt. And, because the pulleys are generally made of aluminum, which has a high thermal conductivity, heat from the engine output shaft is transferred to the drive pulley, which heats the drive belt even more, further decreasing operating life. For these reasons, most snowmobiles are equipped with a spare drive belt, like a spare tire, for replacing drive belts that have failed due to excessive heat.

Efforts to minimize engine movement by removing the isolators and directly attaching the engine to the frame have generally been unsuccessful because the engine vibration is transmitted to the frame, detrimentally affecting operator comfort, and increasing fatigue failure of snowmobile components attached to the frame.

Another shortcoming of conventional snowmobile drive trains is the jack shaft and drive chain. The driven pulley is connected to a jack shaft that runs across the engine bay to chain-driven reduction gears. Endless track sprockets are connected to the reduction gears through another shaft. The extra rotational mass and weight of these components, combined with the relative movement between the two pulleys, results in a drive train efficiency of about 50%. This means that only about half of the engine's power is transmitted to the endless track for propelling the snowmobile. Moreover, the extra weight of the jack shaft and related components increases the overall snowmobile weight, further decreasing efficiency and performance.

Therefore, there exists a need for a snowmobile drive train that maintains a constant alignment between the two pulleys and reduces the weight and complexity of the drive train system, increasing efficiency.

### SUMMARY OF THE INVENTION

The present invention alleviates to a great extent the disadvantages of conventional snowmobile drive trains by providing a drive train system that maintains the drive and driven pulleys in a fixed relationship relative to each other, while allowing the drive belt to be easily removed from the pulleys.

In a preferred embodiment, a support member is located adjacent to the snowmobile engine. The drive pulley and driven pulley are rotatably mounted to the support member, with the drive belt looped around the pulleys, the pulleys mounted on the support member so that the drive belt can be removed from the snowmobile by passing the drive belt over the pulleys. The support member maintains the two pulleys in a precise alignment, greatly extending the operating life of the drive belt and simultaneously increasing drive train efficiency.

An isolation member couples the drive pulley to the engine output shaft, thereby permitting the engine to move relative to the support member, so that operator comfort is maintained.

According to one aspect of the present invention, the support member may include two gears for coupling the driven pulley to the endless track. The gears decrease the weight and complexity of the drive train, while increasing efficiency.

According to another aspect of the present invention, the support member is constructed to absorb heat generated by the engine, thereby minimizing heat transfer to the pulleys. By decreasing engine heat transfer to the pulleys, the operating life of the drive belt is substantially increased.

In yet another aspect of the present invention, a housing is structured to encompass the pulleys and drive belt, increasing ascetics of the snowmobile, and protecting the pulleys and drive belt from the environment.

These and other features and advantages of the present invention will be appreciated from review of the following detailed description of the invention, along with the accompanying figures in which like reference numerals refer to like parts throughout. It should be understood that the description and examples, while indicating preferred embodiments of the present invention, are not intended to limit the scope of the invention, and various changes and modifications within the spirit and scope of the invention will become apparent to those skilled in the art.

### BRIEF DESCRIPTION OF THE DRAWINGS

FIG. 1 is a perspective view of a snowmobile incorporating a drive train constructed according to one embodiment of the present invention;

FIG. 2 is a perspective view of a drive train support member constructed according to a preferred embodiment of the present invention;

FIG. 3 is a side view of the drive train support member illustrated in FIG. 2;

FIG. 4 is a partial sectional view taken along cutting plane 4—4 of FIG. 3;

FIG. 5 is a partial sectional view taken along cutting plane 5—5 of FIG. 3; and

FIG. 6 is an exploded view of the isolation member illustrated in FIG. 2.

It will be recognized that some or all of the Figures are schematic representations for purposes of illustration and do not necessarily depict the actual relative sizes or locations of the elements shown.

### DETAILED DESCRIPTION OF THE INVENTION

In the following paragraphs, the present invention will be described in detail by way of example with reference to the attached drawings. Throughout this description, the preferred embodiment and examples shown should be considered as exemplars, rather than as limitations on the present invention. As used herein, “the present invention” refers to any one of the embodiments of the invention described herein. Reference to various features of the “present invention” in this document does not mean that the claimed embodiments must include all the referenced features.

The present invention contemplates a snowmobile drive train that isolates the drive train pulleys from engine heat and vibration and mounts the pulleys rigidly, thereby maintaining precise pulley alignment. In addition, the present invention eliminates the jack shaft and chain drive found on conventional snowmobiles, and instead mounts two gears in a support member. This decreases drive train weight and allows the engine to be mounted lower in the frame, thereby lowering the center of gravity, which improves the snowmobile handling and stability characteristics.

Referring to FIG. 1, a snowmobile 10 incorporating a drive train assembly 12 constructed according to the present invention is illustrated. The snowmobile 10 comprises a seat 30 for the operator and a handlebar assembly 25 that steers the skis 20, which are connected to the snowmobile 10 through the front suspension assembly 22. An engine 32 drives the endless track 15 through the drive train assembly 12, the endless track 15 positioned around a rear suspension assembly 18. The rear suspension assembly 18 and other features of the snowmobile 10 are further described in U.S. patent application, Ser. No. 09/502,280, entitled “SNOWMOBILE SUSPENSION”, filed Feb. 10, 2000, which is incorporated herein by reference in its entirety.

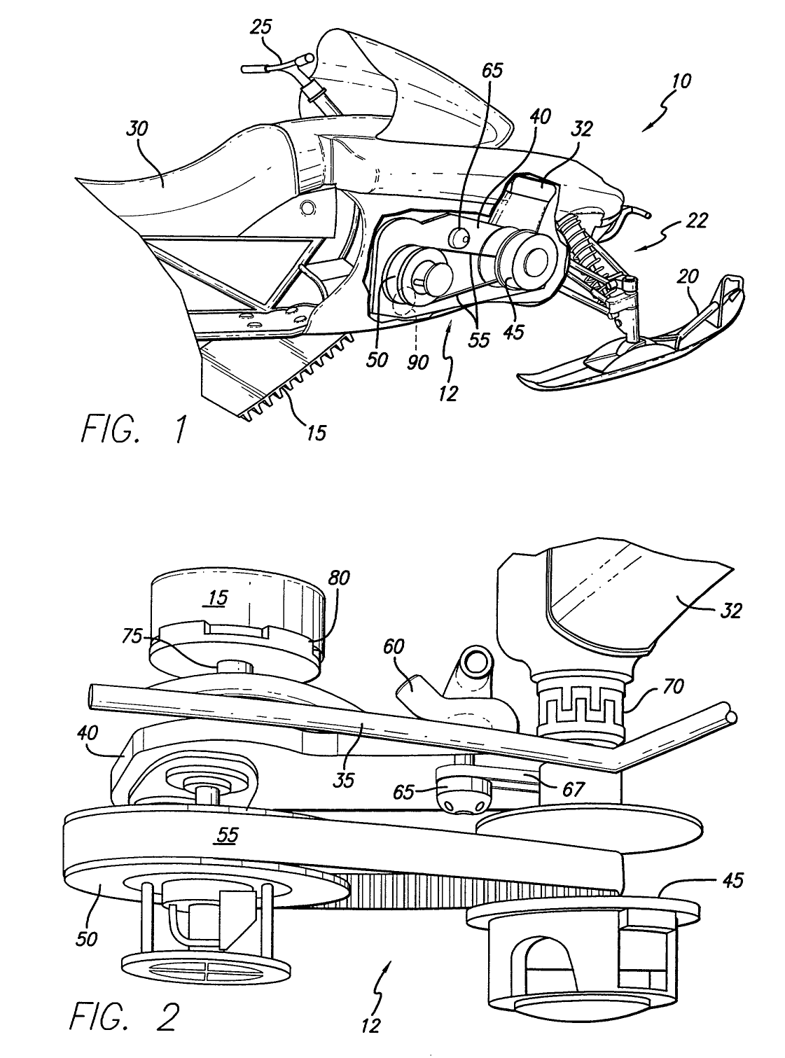

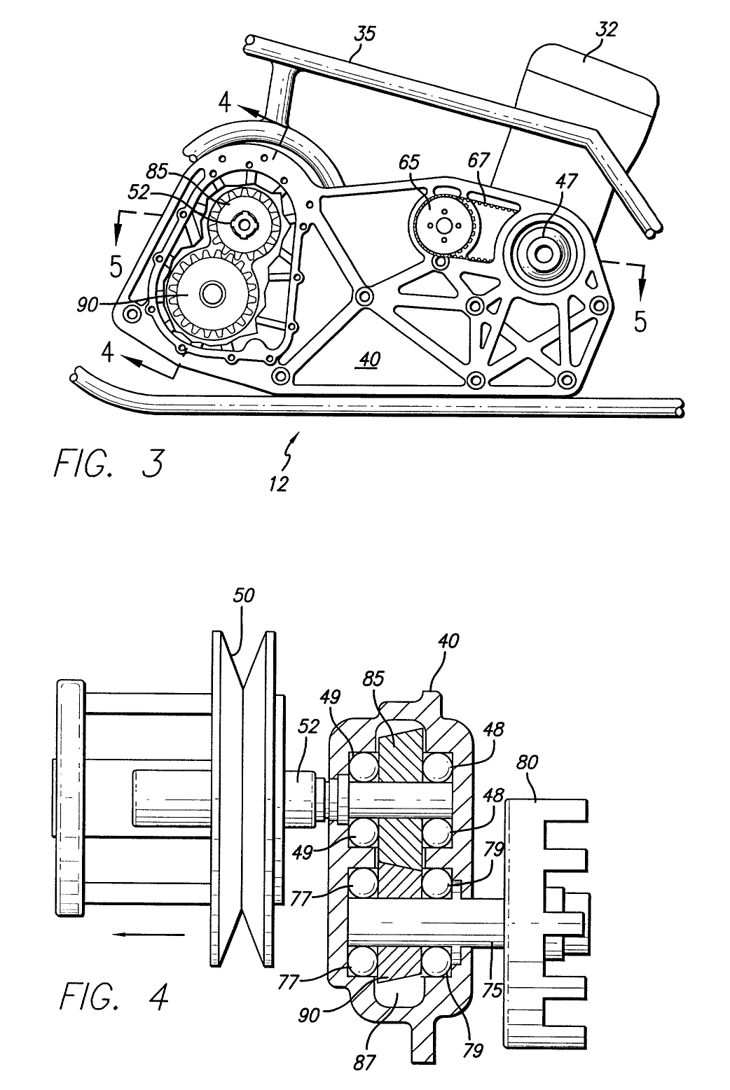

Referring to FIGS. 2 and 3, a drive train casing or support member 40 is illustrated. The support member 40 comprises a rigid member that is preferably cast aluminum. Other embodiments can be made of other materials such as steel or composite materials such as Kevlar or carbon fiber. The support member 40 is bolted or otherwise attached to the frame 35. The support member 40 is located adjacent to the engine 32 and is connected to the engine 32 by the isolator assembly 70. Located outboard of the support member 40 is a drive pulley 45 and a driven pulley 50. In a preferred embodiment, both pulleys 45 and 50 are centrifugal clutches arranged to form a constantly variable transmission. However, unlike conventional snowmobile drive train arrangements, the pulleys 45 and 50 of the present invention are rigidly mounted on the support member 40 so that relative movement between the pulleys 45 and 50 is eliminated.

Referring to FIGS. 2-3, another aspect of the present invention is illustrated. The engine water pump 60 is also mounted on the support member 40. The water pump 60 is mounted on the inboard side of the support member 40 with a water pump pulley 65 located on the outboard side of the support member pulley 40. A water pump belt 67 connects the water pump pulley 65 to the drive pulley axle 47. Therefore, when the drive pulley axle 47 rotates, the water pump pulley 65 rotates which drives the water pump 60, circulating water through the engine 32 cooling system. By mounting the water pump 60 to the support member 40, the water pump 60 is isolated from the harsh engine 32 vibrations, which can cause fatigue failures of metal components, such as the water pump 60.

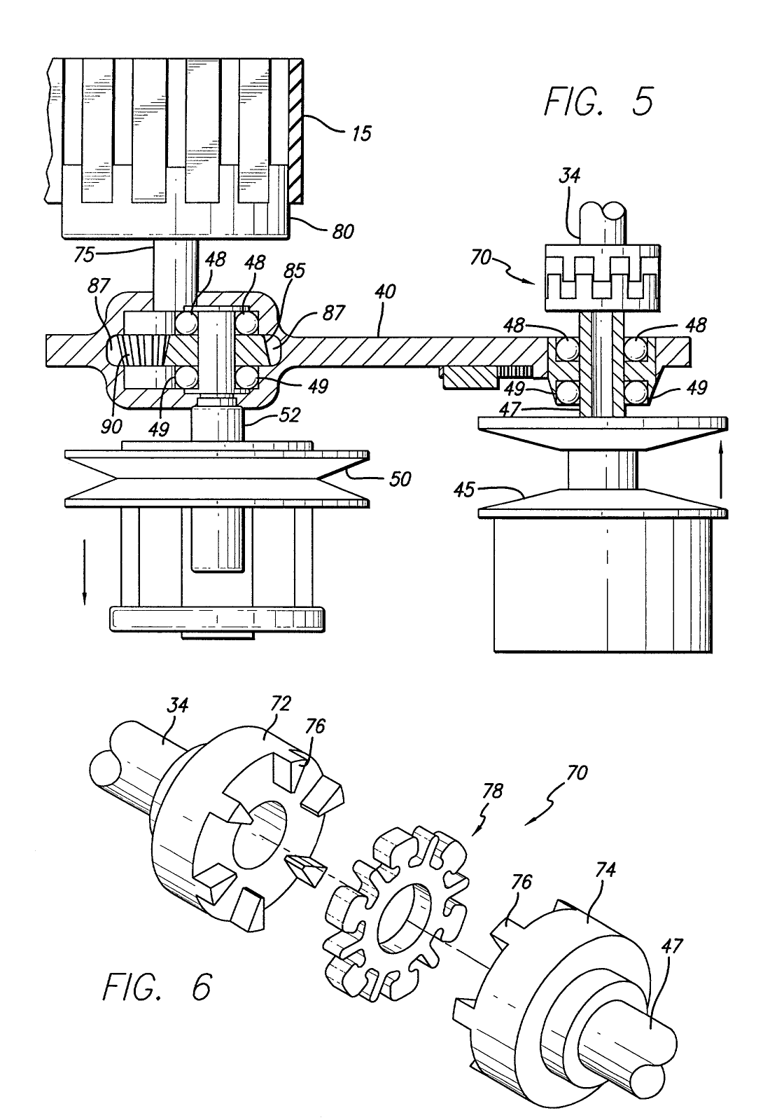

Referring to FIGS. 4 and 5, two cross-sectional views of the drive train assembly 12 are illustrated. The drive pulley 45 and the driven pulley 50 are rotatably mounted in the support member 40 by pulley bearings 49. In a preferred embodiment, the pulley bearings 49 are tapered roller bearings, but other types of bearing arrangements such as needle bearings, ball bearings, journal bearings or other suitable bearing arrangements are contemplated. Because the drive and driven pulleys 45 and 50 are securely but rotatably mounted in the support member, the pulleys are free to rotate. However, they are not free to move closer together or in other directions. This ensures that a drive belt 55 that is positioned between the pulleys 45 and 50 operates at maximum efficiency. Relative movement between the drive pulley 45 and driven pulley 50 causes the edges of the drive belt 55 to slip or otherwise not engage correctly with the pulleys 45 and 50, thereby causing heat buildup in the drive belt 55 and decrease efficiency in the drive train.

Another feature of the present invention incorporated within the drive train assembly 12 is that even though the drive pulley 45 and driven pulley 50 are rigidly mounted, removal of the drive belt 55 can still be easily accomplished by simply looping the drive belt 55 over the pulleys 45 and 50. Easy replacement of the drive belt 55 is important because when a drive belt 55 fails, the snowmobile is inoperable, leaving the operator possibly stranded in winter conditions. The operator must be able to easily install another drive belt 55 without the use of tools. The drive train assembly 12 constructed according to the present invention allows an operator to easily install a drive belt 55 over the drive and driven pulleys 45 and 50.

A snowmobile 10 constructed according to the present invention attaches the engine 32 to the frame 35 by isolation mounts. The engine isolation mounts are generally comprised of a rubber and are structured to absorb relative movement. The isolation mounts absorb the engine 32 vibration minimizing transfer of the engine 32 vibration to the operator. In a conventional snowmobile drive train arrangement, the engine output shaft 34 is directly connected to the drive pulley 45. When the snowmobile accelerates or decelerates, the engine moves on the isolation mounts and generates relative movement between the drive pulley 45 and the driven pulley 50.

In the present invention, an isolation member or isolator assembly 70 is positioned between the engine output shaft 34 and the drive pulley 45 to absorb engine 32 vibration. Illustrated in FIGS. 2, 5 and 6, the isolator assembly 70 includes an engine hub 72 connected to the engine output shaft 34. A drive pulley hub 74 is connected to the drive pulley axle 47. The engine hub 72 and drive pulley hub 74 contain projections 76 that engage an isolator 78. The isolator 78 includes isolator projections 82 that engage the projections 76 on both the engine hub 72 and the drive pulley hub 74. In a preferred embodiment, the isolator is made from a durable rubber, but other types of materials such as urethanes, polyurethanes, polymers, elastomers and other suitable materials are contemplated. In a preferred embodiment, the isolator 78 is oil-resistant and remains flexible at the low temperatures encountered during winter conditions.

One advantage of the present invention is that the isolator assembly 70 greatly reduces the amount of heat transferred from the engine output shaft 34 to the drive pulley 45. The rubber or other suitable type of material of the isolator 78 acts to insulate the drive pulley 45 from engine heat. In addition, in one embodiment, the support member 40 is cast from aluminum and absorbs heat transferred from the engine 32 to the support member 40. In this manner, heat transferred to the drive pulley 45 is greatly reduced, which greatly increases the life of the drive belt 55 because the drive belt is not subjected to engine temperatures and temperature cycling.

Referring to FIGS. 4 and 5, the drive pulley 45 and driven pulley 50 are rotatably mounted in the support member 40 by respective pairs of inboard pulley bearings 48 and outboard pulley bearings 49. The bearing sets 48 and 49 are located about the drive pulley axle 47 and the driven pulley axle 52, and resist the bending forces that are transmitted from the drive pulley 45 and the driven pulley 50 to their respective axles 47 and 52.

Specifically, the drive belt 55 pulls the drive pulley 45 and driven pulley 50 together during snowmobile 10 accelerations and decelerations. The force exerted by the drive belt 55 is resisted by the inboard and outboard pulley bearings 48 and 49. Therefore, the arrangement, as illustrated in FIG. 4, permits the drive pulley 45 and driven pulley 50 to be securely mounted in the support member 40, yet also permits the drive belt 55 to be easily removed without removing any additional components from the drive train assembly 12.

Referring to FIGS. 2-4, another aspect of the present invention is illustrated. A pulley gear 85 and a sprocket gear 90 are rotatably mounted within the support member 40. The pulley gear 85 is connected to the driven pulley 50 through the driven pulley axle 52. The pulley gear 85 engages the sprocket gear 90. The sprocket gear 90 attaches to at least one sprocket 80 through sprocket axle 75. The sprocket axle 75 is rotatably mounted in the support member 40 by an inboard sprocket bearing 77 and an outboard sprocket bearing 79. In a manner similar to the pulley bearings 48 and 49, discussed above, the sprocket bearings 77 and 79 resist the bending forces transmitted to the sprocket axle 75 from the sprocket 80.

In a preferred embodiment, the sprocket axle 75 includes three or more sprockets 80 that drive the endless track 15. Other arrangements of sprockets or other devices to drive the endless track 15 can be employed. Preferably, the pulley gear 85 and sprocket gear 90 are sealed within the support member 40, keeping dust, dirt, snow, water and other elements from entering the gear cavity 87. A gear ratio between the pulley gear 85 and sprocket gear 90 can range from between 1.5:1 up to 2:1. This ratio is necessary to reduce the rotational velocity of the driven pulley 50 to a rotational velocity suitable for the sprocket axle 75 that drives the endless track 15.

In one embodiment, the pulley gear 85 has 17 teeth and the sprocket gear 90 has 28 teeth, resulting in a gear ratio of about 1.6:1. Other ratios designed for different engine horsepower and torque characteristics can be employed. For example, an engine having low horsepower and torque would employ a gear ratio of about 1.5:1, and an engine having more horsepower and torque would employ a gear ratio of about 2:1. It is appreciated that the gear ratios can be changed to suit specific requirements, such as hill climbing, racing, and other activities requiring specific gear ratios. By including the pulley gear 85 and sprocket gear 90 within the support member 40, the jack shaft and chain drive arrangement of conventional snowmobiles is eliminated. Because the jack shaft and chain drive are eliminated, the engine 32 can be rotated 180 degrees, so that the output shaft 34 is on the right side of the engine 32, and the engine exhaust manifold (not illustrated) facing toward the rear of the snowmobile 10. With the engine exhaust manifold facing rearward, an engine exhaust (not shown) can be positioned under the seat 30.

The elimination of the jack shaft and chain drive decreases the number of parts in the drive train assembly 12 and increases the efficiency of the drive train assembly 12. Also, elimination of the jack shaft and chain drive allows the engine 32 to be mounted lower in the frame 35 increasing the snowmobile 10 stability. One advantage of the present invention is that the support member 40 has been designed to position the engine 32 as low as possible by optimizing the location of the pulley gear 85 and sprocket gear 90.

Many variations of the above-described snowmobile drive train are possible. One skilled in the art will appreciate that the present invention can be practiced by other than the preferred embodiments, which are presented in this description for purposes of illustration and not of limitation, as the present invention is limited only by the claims that follow. It is noted that various equivalents for the particular embodiments discussed in this description may practice the invention as well.

What is claimed is:

1. A snowmobile comprising:
an engine including an output shaft;
a support member located adjacent to the engine;
a drive pulley and a driven pulley, each pulley rotatably mounted to the support member, with a drive belt positionable around the pulleys, the pulleys mounted on the support member so that the drive belt can be removed from the snowmobile by passing the drive belt over the pulleys.

2. The snowmobile of claim 1, wherein the support member is structured to maintain the drive pulley and the driven pulley in a substantially fixed position relative to each other.

3. The snowmobile of claim 1, further including an isolation member coupling the output shaft to the drive pulley.

4. The snowmobile of claim 1, further including an engine water pump mounted on the support member.

5. The snowmobile of claim 1, further including a gear case located within the support member, the gear case including a sprocket gear and a pulley gear.

6. The snowmobile of claim 5, wherein the pulley gear is coupled to the driven pulley, and the sprocket gear is coupled to a sprocket axle, and wherein the pulley gear and the sprocket gear are rotatably coupled within the gear case.

7. The snowmobile of claim 6, wherein a gear ratio between the pulley gear and the sprocket gear can range between about 2.0:1 and about 1.5:1.

8. The snowmobile of claim 1, wherein the support member absorbs heat generated by the engine, thereby minimizing heat absorbed by the drive pulley.

9. The snowmobile of claim 1, further including a housing structured to completely enclose the drive and driven pulleys.

10. The snowmobile of claim 1, wherein the support member comprises a substantially rigid casing.

11. The snowmobile of claim 1, wherein the drive and driven pulleys comprise centrifugal clutches.

12. A snowmobile employing a drive belt, the snowmobile comprising:
an engine including an output shaft;
a support member located adjacent to the engine;
a drive pulley and a driven pulley, each pulley having an inboard side and an outboard side, with each pulley rotatably mounted to the support member on the inboard side only.

13. The snowmobile of claim 12, further including an isolation member coupling the output shaft to the drive pulley.

14. The snowmobile of claim 12, further including an engine water pump mounted on the support member.

15. The snowmobile of claim 12, further including a gear case located within the support member, the gear case including a sprocket gear and a pulley gear.

16. The snowmobile of claim 15, wherein the pulley gear is coupled to the driven pulley, and the sprocket gear is coupled to a sprocket axle, and wherein the pulley gear and the sprocket gear are rotatably coupled within the gear case.

17. The snowmobile of claim 16, wherein a gear ratio between the pulley gear and the sprocket gear can range between about 2.0:1 and about 1.5:1.

18. The snowmobile of claim 12, wherein the support member absorbs heat generated by the engine, thereby minimizing heat absorbed by the drive pulley.

19. The snowmobile of claim 12, further including a housing structured to completely enclose the drive and driven pulleys.

20. The snowmobile of claim 12, wherein the support member comprises a substantially rigid casing.

21. The snowmobile of claim 12, wherein the drive and driven pulleys comprise centrifugal clutches.

22. A drive train for a snowmobile employing an endless track and an engine having an output shaft, the drive train comprising:
a support member coupled to a frame, the support member located adjacent to the engine;
a drive pulley and a driven pulley, each pulley rotatably mounted to the support member, with an isolation member coupled to the drive pulley and to the output shaft; and
a sprocket gear and a pulley gear rotatably coupled within the support member, the pulley gear coupled to the driven pulley and the sprocket gear coupled to the endless track.

23. The drive train of claim 22, further including an engine water pump mounted on the support member.

24. The drive train of claim 22, further including a gear case located within the support member, the gear case including the sprocket gear and the pulley gear.

25. The drive train of claim 22, wherein the support member absorbs heat generated by the engine, thereby minimizing heat absorbed by the drive pulley.

26. The drive train of claim 22, further including a housing structured to completely enclose the drive and driven pulleys.

27. The drive train of claim 22, wherein the support member comprises a substantially rigid cast-aluminum casing.

28. The drive train of claim 22, wherein the drive and driven pulleys comprise centrifugal clutches.

29. The drive train of claim 22, wherein a gear ratio between the pulley gear and the sprocket gear can range between about 2.0:1 and about 1.5:1.
